(19) United States
(12) Patent Application Publication
(10) Pub. No.: US 2024/0214307 A1
(43) Pub. Date: Jun. 27, 2024

(54) METHODS AND APPARATUSES FOR CONTROLLING TRAFFIC FLOW IN A NETWORK

(71) Applicant: META PLATFORMS, INC., Menlo Park, CA (US)

(72) Inventors: Christopher Hellberg, New York, NY (US); Bede Carroll, Redwood City, CA (US); David Trevor Miles, Colfax, CA (US)

(21) Appl. No.: 18/145,318

(22) Filed: Dec. 22, 2022

(51) Int. Cl. H04L 45/74; H04L 45/00; H04L 45/122

(52) U.S. Cl. CPC H04L 45/74; H04L 45/122; H04L 45/566

(57) ABSTRACT

The present application at least describes a method including a step of receiving, at a first interface of a router from a first device, traffic including an IP packet. The IP packet may include a multicast or broadcast destination address. The method may also include a step of determining the received IP packet belongs in a Layer 3 broadcast domain of the router. The method may further include a step of instantiating, at the Layer 3 broadcast domain, a replica of the IP packet. The method may even further include a step of transmitting, via a second interface of the router, the replica to a second device.

### FIELD

The present application generally is directed to methods and apparatuses for controlling traffic flow in a network.

### BACKGROUND

Generally, routing devices such as routers are configured to route IP datagrams between interfaces. The router may exchange data between logically attached, remote devices sharing a common IP subnet interconnected by a common broadcast or bridging domain. The broadcast domain may be established between a remote device and a router as a Layer 2 interface.

Alternatively, a broadcast domain may be established with an intermediate IP network existing between the remote device and routing device. An overlay encapsulation protocol such as generic routing encapsulation (GRE) or virtual extensible local area network (VXLAN) may be employed to provide a Layer 2 pathway over an intermediate IP network.

A router with one or more Layer 3 interfaces may be configured to separate broadcast domains of remote devices. Layer 3 interfaces generally are not configured to forward broadcast traffic. They are also not configured to forward certain types of multicast traffic intended to remain local to a link. That is, a router typically would not propagate the packet traffic to other Layer 3 interfaces. Instead, the router would propagate such packet traffic to other Layer 2 interfaces associated with the broadcast domain.

### BRIEF SUMMARY

One aspect of the application at least describes a method including a step of receiving, at a first interface of a router from a first device, traffic including an IP packet. The IP packet may include a multicast or broadcast destination address. The method may also include a step of determining the received IP packet belongs in a Layer 3 broadcast domain of the router. The method may further include a step of instantiating, at the Layer 3 broadcast domain, a replica of the IP packet. The method may even further include a step of transmitting, via a second interface of the router, the replica to a second device.

Another aspect of the application at least describes an apparatus including a non-transitory memory including stored instructions for controlling traffic. The apparatus also includes a processor operably coupled to the non-transitory memory that is configured to execute the stored instructions. One of the instructions may include receiving, at a first Layer 3 interface of a router, traffic including an IP packet. The packet may include a multicast or broadcast destination address from a first device. Another one of the instructions may include determining, the received IP packet belongs in a Layer 3 broadcast domain of the router. Yet another one of the instructions may include instantiating, at the Layer 3 broadcast domain, a replica of the IP packet. A further one of the instructions may include transmitting, via a second Layer 3 interface of the router, the replica to a second device.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings example embodiments of the disclosed subject matter. However, the disclosed subject matter is not limited to the specific methods and devices disclosed. In addition, the drawings are not necessarily drawn to scale. In the drawings:

FIG. 1 illustrates a communication system in accordance with the present application.

FIG. 2 illustrates an example node in accordance with the present application.

FIG. 3 illustrates a block diagram of an example computing system in accordance with the present application.

FIGS. 4A-4D illustrate example network architectures of traffic received and/or transmitted via a router in accordance with the present application.

FIG. 5 illustrates an example network architecture employing modified forwarding by a router in accordance with an example embodiment of the present application.

FIG. 6 illustrates a flowchart in accordance of the present application.

The figures depict various embodiments for purposes of illustration only. One skilled in the art will readily recognize from the following discussion that alternative embodiments of the architectures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary,” as used herein, is not provided to convey any qualitative assessment, but instead merely to convey an illustration of an example. Thus, use of any such terms should not be taken to limit the spirit and scope of embodiments of the present application. It is to be understood that the methods and systems described herein are not limited to specific methods, specific components, or to particular implementations.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

It will be understood the methods and apparatuses described in the present application may allow for a node, such as for example a router, configured with specific protocols to exchange multicast and broadcast traffic between remote devices. Techniques and architectures are described hereinafter whereby a router may receive and/or transmit these two types of traffic between groups of interfaces. In so doing, remote devices connected to different router interfaces may seamlessly receive multicast DNS and/or broadcast traffic as if they shared a common Ethernet broadcast domain.

In one or more examples, the router may be configured with a set of specified functionality that augment its forwarding behavior. In particular, the router may be configured to determine that an IP packet, e.g., traffic, received over a first interface from a first remote device belongs in a Layer 3 broadcast domain of the router. If this is the case, a protocol may be executed to produce a replica of the IP packet. As will be further understood herein, the replica of the IP packet may include an identical Destination IP and Source IP as transmitted by the first remote device sending the IP packet. Another protocol may be executed such that an Ethernet header may be accompany the replica of the IP packet. The Ethernet header may include an indication of the destination MAC as set by the first remote device. Importantly, a source MAC of the Ethernet header may provide an indication of a source MAC of the router. The replica subsequently may be transmitted over a second interface to a second remote device.

In some embodiments, the plural remote devices communicating with the router may reside in a common bridging domain. In other embodiments, the bridging domain may include plural remote devices that do not share a common IP subnet.

In one or more examples, the router may be selected to be a broadband network gateway (BNG). The BNG may be able to connect remote devices, such as for example customer premises equipment (CPE), via DSL broadband modems to a network. The BNG may also help establish and manage subscriber sessions for customer premises equipment (CPE). The CPE may include but is not limited to laptops, tablets and smart phones.

One of the advantages envisaged in the present application is to allow devices that require Layer 2 connectivity to communicate with each other over a Layer 3 gateway. In so doing, the router can employ simple forwarding methods described in the present application without requiring the additional complexity of an overlay protocol such as VXLAN or VPLS.

One further advantage envisaged in the present application is to allow operators to upgrade their routers with the capability embodied in this application to continue to support legacy devices whose application functions may not support a Layer 3 intermediate gateway.

One additional advantage envisaged in the present application is for a router to avoid the use of proxy functionality that may have been used as a way to provide similar functionality to that in the present application.

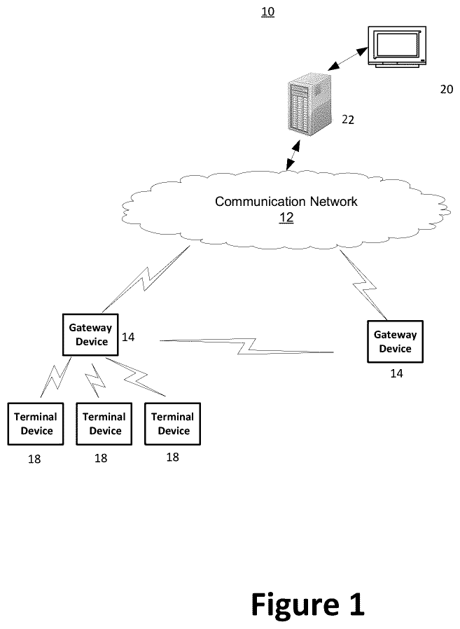

FIG. 1 is a diagram of an example communication system 10 in which one or more disclosed embodiments may be implemented. As shown in FIG. 1, the communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. For example, the communication network 12 may comprise other networks such as a core network, the Internet, a sensor network, an industrial control network, a personal area network, a fused personal network, a satellite network, a home network, or an enterprise network for example.

It will be appreciated that any number of gateway devices 14 and terminal devices 18 may be included in the communication system 10 as desired. Each of the gateway devices 14 and terminal devices 18 are configured to transmit and receive signals via the communication network 12 or direct radio link. The gateway device 14 allows wireless devices, e.g., cellular and non-cellular as well as fixed network devices, e.g., PLC, to communicate either through operator networks, such as the communication network 12 or direct radio link. For example, the devices 18 may collect data and send the data, via the communication network 12 or direct radio link, to an application 20 or devices 18. Further, data and signals may be sent to and received from the application 20 via a service Layer 22, as described below. In one embodiment, the service Layer 22 may be a PCE. Devices 18 and gateways 14 may communicate via various networks including, cellular, WLAN, WPAN, e.g., Zigbee, 6LoWPAN, Bluetooth, direct radio link, and wireline for example.

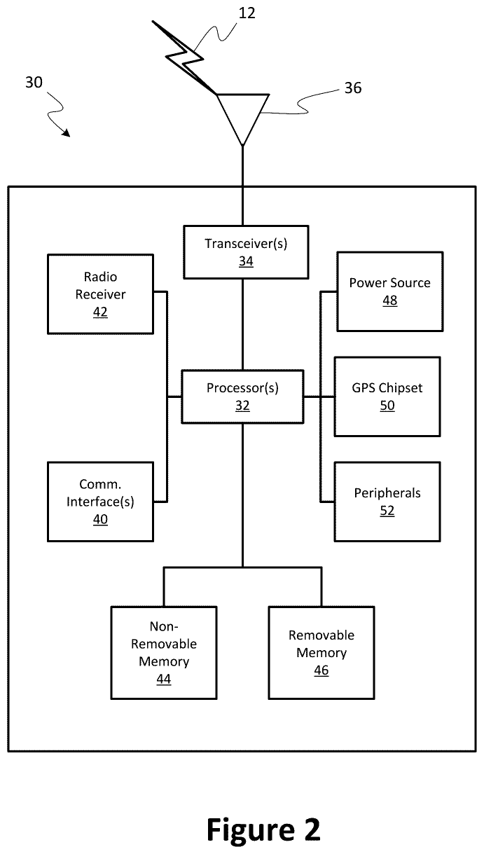

FIG. 2 illustrates a block diagram of an exemplary hardware/software architecture of user equipment (UE) 30. The architecture may be used in conjunction with the system depicted in FIG. 1. As shown in FIG. 2, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an exemplary embodiment, the camera 54 is a smart camera configured to sense images appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-Layer programs (e.g., browsers) and/or radio access-Layer (RAN) programs and/or other communications programs. The processor 32 may also perform security operations such as authentication, security key agreement, and/or cryptographic operations, such as at the access-Layer and/or application Layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

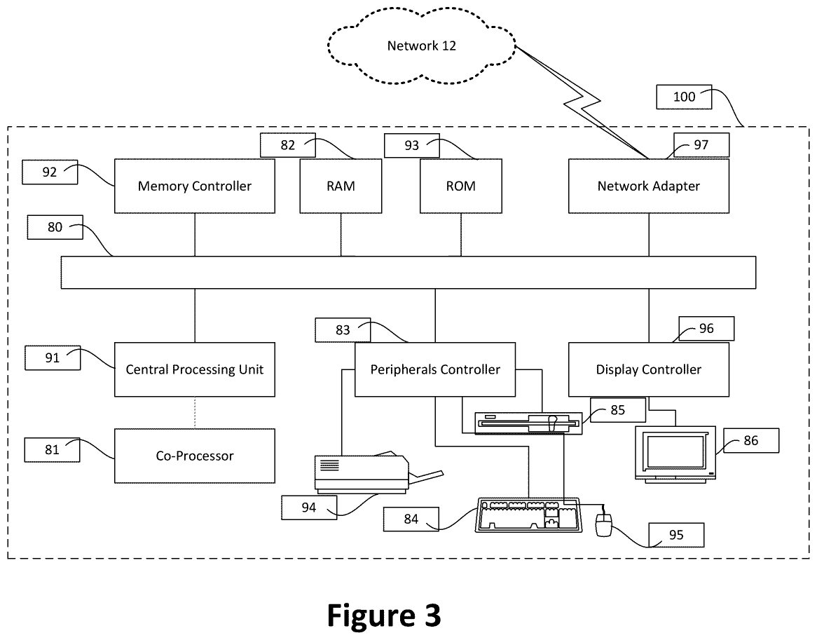

FIG. 3 is a block diagram of an exemplary computing system 100 which may also be used to implement components of the system or be part of the UE 30. The computing system 100 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 100 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 100 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 100. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 100 may contain communication circuitry, such as for example a network adaptor 97, that may be used to connect computing system 100 to an external communications network, such as network 12, to enable the computing system 100 to communicate with other nodes (e.g., UE 30) of the network.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### Modified Protocols at the Router

According to an aspect of the present application, a router may be configured to receive Ethernet datagrams arriving from a remote device. These datagrams may be encapsulated using an overlay tunneling protocol such as for example GRE or MPLS. Alternatively, the router may decapsulate datagrams that arrive as Ethernet frames without an overlay encapsulation protocol. In reverse, the router encapsulates Ethernet frames to remote clients with an optional tunneling protocol header.

As generally understood, GRE is a stateless protocol that allows two endpoints to create tunnels between themselves and provide an interconnection of networks behind those endpoints. GRE involves an endpoint that encapsulates some payload (e.g. an Ethernet or an IP frame) with a GRE and IP header. The IP header contains sufficient information for intermediate routers to forward the packet to the other endpoint. The receiving endpoint associates the packet with a particular tunnel based on source and destination IP addresses. IP addresses can be based on either IPv4 or IPv6 formats. The GRE header also contains a protocol identifier, which indicates to the receiving endpoint how to treat the inner payload once the GRE header has been removed.

Some routers, such as for example a broadband network gateway (BNG), may not only provide routing and forwarding capabilities but also session state management for connected remote devices and their corresponding clients. The management may include cases of stateless protocols such as IP. The types of devices may include but are not limited to laptops, tablets, smart phones and other routers.

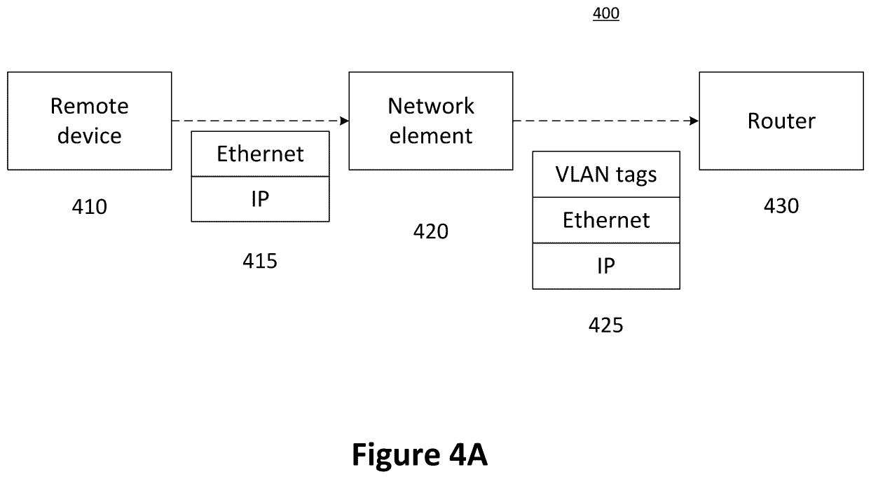

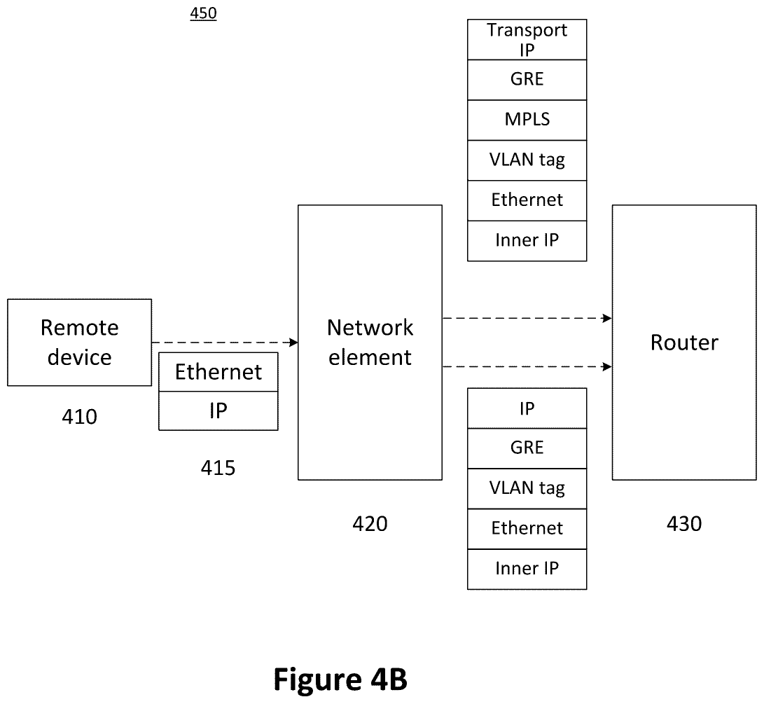

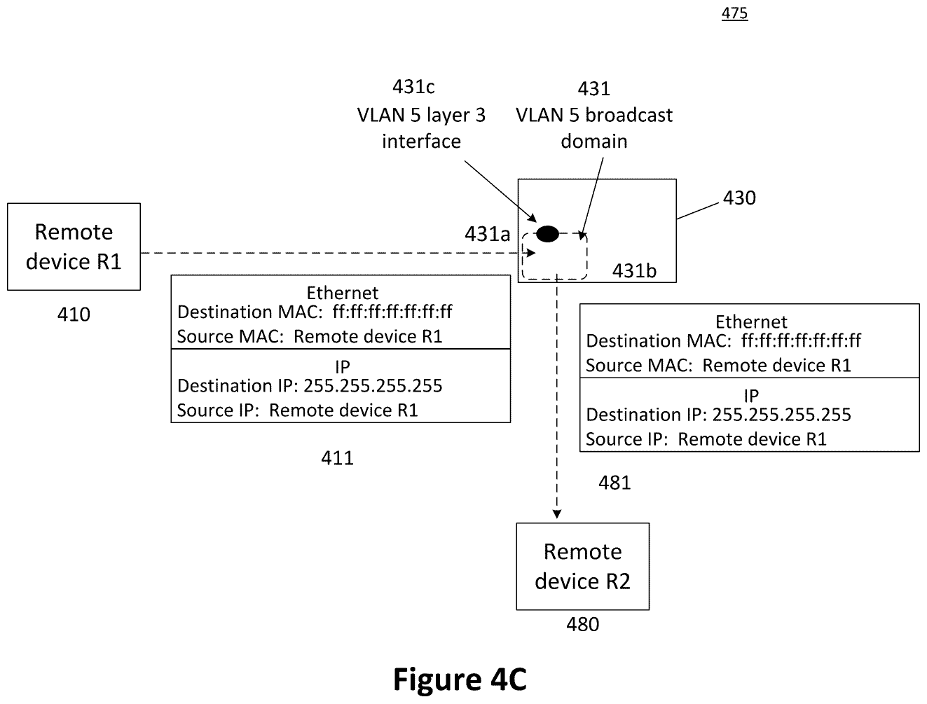

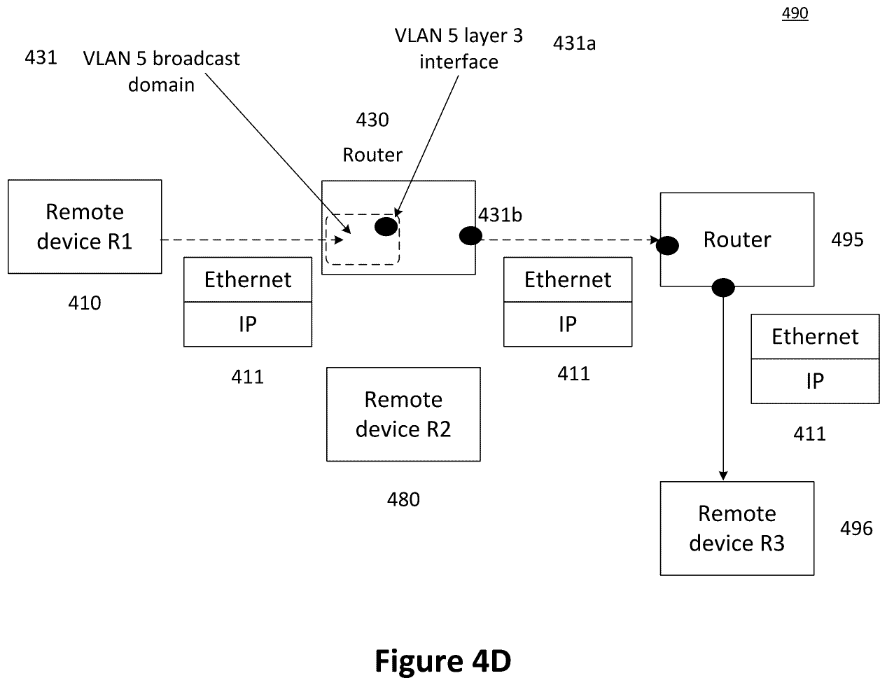

FIG. 4A illustrates an example network architecture 400 in accordance with the present application. Network architecture 400 includes a remote device 410 that sends IP over Ethernet traffic 415 towards a network element 420. The network element 420 may encapsulate Ethernet-encapsulated IP datagrams in one or more VLAN tags 425. The inner payload may either be IPv4 or IPv6 and generalized here as IP. The outer IP header may be IPv4 or IPv6 and also generalized here as IP. A router 430 may decapsulate VLAN tags to process the inner IP payload.

FIG. 4B illustrates another example network architecture 450. Here, the remote device 410 may send IP over Ethernet traffic 415 towards network element 420. The router 430 may decapsulate Ethernet-encapsulated IP datagrams that are encapsulated in a GRE tunnel header. The inner payload may be IPv4 or IPv6 packets and is generalized here as IP unless there are specific behavioral differences between IPv4 and IPv6. The outer IP header may be IPv4 or IPv6 and also generalized here as IP. Network element 420 may have separate tunnels towards the router 430 that employs two concurrent tunneling protocols. One of the tunneling protocols may be GRE. Another one of the tunneling protocols may be MPLS.

In one embodiment, the router 430 may decapsulate the GRE protocol to access the Ethernet payload. In an alternative embodiment, the router 430 may decapsulate the MPLS protocol to access the Ethernet payload. While VLAN headers may be depicted as being imposed on the datagram before the ethernet payload, the source and destination MAC addresses are prepended ahead of any VLAN tags which may precede the final Ethernet type field.

According to a typical Ethernet bridging domain, VLAN IDs identify the elements that share a common bridging or broadcast domain. In this aspect, none of the broadcast, unicast or multicast Ethernet frames from one Ethernet broadcast domain would appear in a different broadcast domain without the use of a routing device. Ethernet frames with identical host MAC addresses but different VLAN IDs do not conflict with one another. These semantics are described in IEEE standard 802.1Q.

According to another embodiment, after decapsulation of the tunneling headers, such as for example GRE or MPLS, the router may be left with an Ethernet frame. The Ethernet frame may include one or more VLAN tags. VLAN tags may be decapsulated leaving an IP datagram. Typically a router may use one or more properties of the incoming tunneling headers including VLAN tags and attached port as a key to determine the identity of the sending network element. The identity is linked to a forwarding context—such as a VRF—for the datagram before the router performs an IP lookup.

According to yet another embodiment, proxy address resolution protocol (ARP) is a feature that can enable a router to forward IP datagrams between remote devices that are not on a contiguous layer 2 network. For example, a host in a network, e.g., 10.1.1.0/24, may send datagrams to another host on the same network by transmitting an Ethernet frame to the host's hardware or MAC address. A router may provide a proxy ARP interconnection capability between two hosts by creating an ARP reply on behalf of the receiving host with the sending host inserting the router's own MAC address as the destination MAC address in subsequent datagrams.

According to even another embodiment, a router may interconnect multiple interfaces that share one or more common IP subnets. This may be illustrated in the network architecture 475 depicted in FIG. 4C. Here, the router 430 may include two or more VLAN 5 Layer 2 interfaces, e.g., 431a, 431b, located within a common broadcast domain 431. The router 430 maintains a switching table to forward Ethernet frames between interfaces and remote devices.

Any unknown unicast, broadcast or multicast traffic may be replicated among multiple interfaces. As shown in FIG. 4C, remote device 410 may transmit a broadcast frame 411 to the VLAN 5 Layer 2 interface 431a. The router 430 replicates this broadcast frame and employs Layer 2 forwarding rules to transmit the replicated broadcast frame 481 to remote device 480. By employing Layer 3 forwarding rules, the router 430 may alternatively forward unicast and some multicast traffic from its broadcast domain 431 to another IP network using its VLAN 5 Layer 3 interface 431c according to another embodiment.

Yet even a further embodiment shows a network architecture 490 depicted in FIG. 4D. A remote device 410 may send a unicast packet 411 to the router 430 having a Layer 3 interface 431a in the VLAN 5 broadcast domain 431. In this example, the router 430 may transmit the IP packet 411 out its other layer 3 interface 431b to another router 495. The router 495 may transmit the packet to a remote device 496.

### Modified Router Protocols

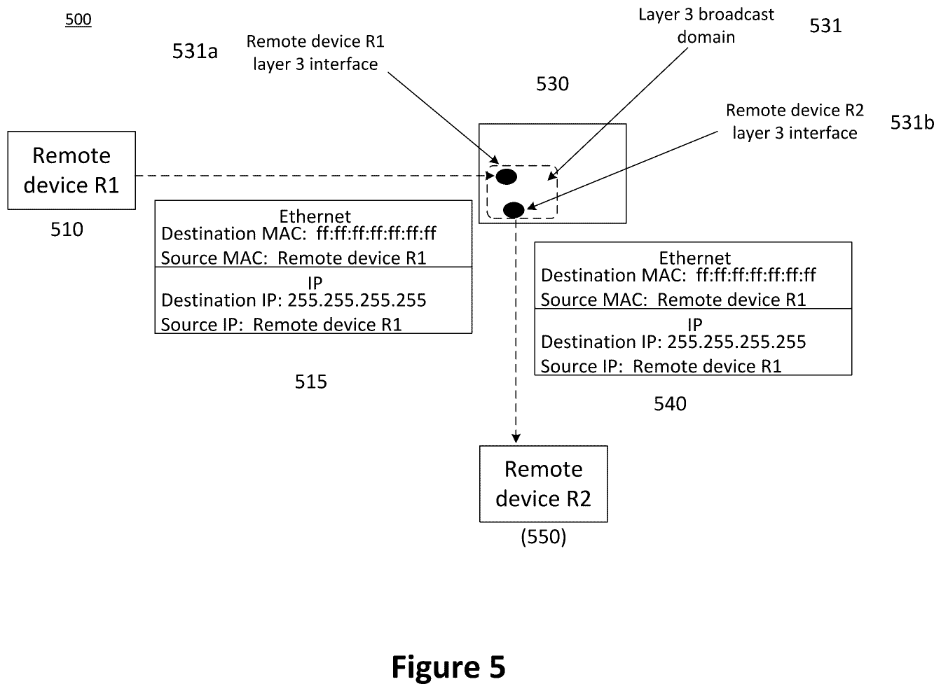

According to yet another aspect of the present application, FIG. 5 illustrates an example network architecture 500 where a first remote device 510 transmits a broadcast packet 515 to a router 530. Packet 515 may include an IPv4 or IPv6 broadcast or multicast packet.

According to an embodiment of this aspect, specific protocols may allow for a modification of the router's 530 forwarding behavior. The router 530 may be configured with functionality allowing it to evaluate whether an IP packet received via a Layer 3 interface, 531a, from the remote device 510 actually belongs in a Layer 3 broadcast domain 531 of the router.

In an embodiment of this aspect, the router 530 may process the IP packet 515 for information within the payload to determine how to handle the packet. If the IP packet is determined to belong in the Layer 3 Broadcast domain 531 (e.g., common bridging domain), the router 530 may transmit a replica 540 of the incoming IP packet 515 to a second remote device 550 over a second interface 531b.

In an embodiment of this aspect, Router 530 may instead process the packet locally and not replicate the packet. An example of this is where certain packets such as IPv6 router solicitation, DHCP or ARP packets may not be desired to be forwarded and handled locally instead.

In another embodiment of this aspect, the replica may include the original Destination IP and Source IP addresses that were used by the device transmitting the packet. An Ethernet header may be added to the replica. The Ethernet header may include an indication of a Source MAC of Router 530. The Ethernet header may also include an indication of a Destination MAC that was originally used by the transmitting device 510.

According to yet a further embodiment, it is envisaged that the router may instantiate a replica of an incoming IP packet upon determining it includes one or more attributes. These attributes may include but are not limited to IPv4 packets whose destination IP address is all-ones, i.e. 255.255.255.255; directed subnet broadcasts where the destination IPv4 address of the packet is the broadcast address of a subnet; Ipv4 link-local multicast traffic; or Ipv6 link-local multicast traffic.

Once the replica is instantiated, the router 530 may perform a lookup for the list of outgoing interfaces in its broadcast domain to transmit the packet. Here, the broadcast domain 531 may be a predetermined group of Layer 3 interfaces associated with one or more remote devices.

In yet another embodiment of this aspect, the replica may be transmitted to one or more remote devices via a second, i.e., outgoing, Layer 3 interface. The first Layer 3 interface, 531a may be distinct from the second Layer 3 interface 531b. In some examples, the interfaces may share a common IP subnet. In other examples, the interfaces may not share a common IP subnet. The bridging domain may include plural remote devices that do not share a common IP subnet. Replication shall occur while employing split horizon forwarding rules, meaning the packet shall not be replicated out the interface in which the packet was received. As a result of these new functionalities implemented by the router 530, remote devices associated with different interfaces may receive multicast DNS and/or broadcast traffic (for example) as if they shared a common Ethernet broadcast domain.

In a further embodiment of this aspect, if the router 530 determines the incoming IP packet 515 is a non-link locally scoped multicast packet (e.g., 232.1.2.3), and that it would otherwise belong in the Layer 3 broadcast domain 531, the incoming IP packet 515 may be instead propagated via another interface 531b to other remote devices based on multicast routing protocol state rather than replicate the packet as described above.

According to a further embodiment of this aspect, the router may enforce tight coupling between Layer 2 and Layer 3 properties (e.g., rejecting a frame whose destination MAC address is the BNG's own unicast MAC address but whose destination IP address is a multicast destination). The present application does not make any assumptions or requirements of a router to enforce consistency between OSI protocol Layers unless explicitly stated.

According to even another embodiment of this aspect, if the destination IPv4 address is a broadcast, or an IPv4 multicast address, or an IPv6 multicast address, not all packets need be replicated. In another embodiment, the router evaluates the destination IP address and other packet attributes to determine whether there is a local process to handle the packet. For example, a router with a remote device that wishes to receive multicast traffic, the router may process the remote client's IGMP packets to maintain its multicast group membership state. Alternatively, a router may receive IPv6 neighbor advertisement packets (defined in IETF RFC 4861-Neighbor Discovery for IP version 6 (IPv6)) destined to the all-nodes multicast address of ff02::1 to process in order to maintain its neighbor cache. If so required, these packets need not be replicated as described above.

According to yet even a further embodiment of this aspect, if the packet is an IPv4 broadcast packet of all ones in the destination address, e.g., 255.255.255.255, or the packet is an IPv4 directed broadcast packet (e.g., a destination address of 100.1.1.255 for a host within a 100.1.1.0/24 subnet), the router may instantiate a replica as described above.

According to another embodiment of this aspect, the router may perform normal IP forwarding in some instances. This may arise if after performing the destination address lookup of the IP packet the router determines the packet is a regular unicast packet that needs to be forwarded to another router or switch. Here, the router may also follow regular forwarding and replication methods for multicast if enabled.

According to even a further embodiment of this aspect, the router may support multiple Layer 3 broadcast domains. Each broadcast domain may include one or more interfaces. By employing split horizon rules, the router may replicate an interesting packet having certain attributes, as described above. The interesting packet may be transmitted to one or more interfaces in the Layer 3 broadcast domain except the interface from which the packet came. Replicated packets can be subject to output packet filter policy applied to outgoing interfaces. An interface may be present in zero or at most, one Layer 3 broadcast domain.

According to an even further embodiment of this aspect, the forwarding process may include inspecting the TTL field of the IP header. If the packet has its time-to-live (“TTL”) field equal to one, a router would not normally forward the packet due to TTL expiry. The router must ignore the TTL field to allow the packet to be propagated to other remote devices as if it were an Ethernet switch regardless of the TTL value.

According to even another embodiment of this aspect, if a router receives a directed broadcast packet (e.g. a destination address of 10.1.1.255 whose network and subnet mask are 10.1.1.0/24) and it has a local interface whose IP address resides in the corresponding IP network, a router may send the packet out that interface. This feature may be disabled.

According to even another embodiment, if a router receives a directed broadcast packet whose incoming interface is present in a Layer 3 broadcast domain, a directed broadcast packet shall forwarded according to replication semantics discussed above. This would include not decrementing the TTL and not dropping the packet if the TTL is equal to one. The router may drop a directed broadcast if the incoming interface is not part of a Layer 3 broadcast domain.

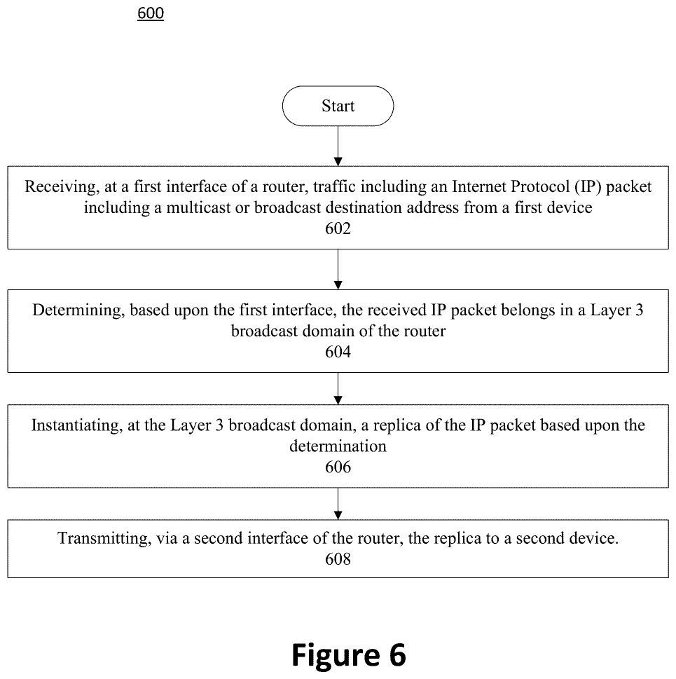

According to yet a further aspect of the present application, a technique for controlling traffic is depicted in the flowchart 600 depicted in FIG. 6. According to step 602, the technique describes receiving, at a first interface of a router, traffic including an Internet Protocol (IP) packet including a multicast or broadcast destination address from a first device. In step 604, the technique describes determining, based upon the first interface, the received IP packet belongs in a Layer 3 broadcast domain of the router In step 606, the technique describes instantiating, at the Layer 3 broadcast domain, a replica of the IP packet based upon the termination. In step 608, the technique describes transmitting, via a second interface of the router, the replica to a second device.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, at a first interface of a router, traffic including an Internet Protocol (IP) packet including a multicast or broadcast destination address from a first device;
determining, based upon the first interface, the received IP packet belongs in a Layer 3 broadcast domain of the router;
instantiating, at the Layer 3 broadcast domain, a replica of the IP packet based upon the determination; and
transmitting, via a second interface of the router, the replica to a second device.

2. The method of claim 1, wherein any one or more of the first interface and the second interface includes a Layer 3 interface.

3. The method of claim 2, wherein the first interface and the second interface are Layer 3 interfaces.

4. The method of claim 1, wherein the router is configured to group multiple interfaces in the Layer 3 broadcast domain.

5. The method of claim 4, further comprising:
transmitting, via the router, the replica to a third device via a third interface.

6. The method of claim 1, further comprising:
adding an Ethernet header to the replica.

7. The method of claim 6, wherein a source MAC of the Ethernet header includes an indication of a source MAC of the router.

8. The method of claim 6, wherein a destination MAC of the Ethernet header includes an indication of a destination MAC of the IP packet.

9. The method of claim 1, wherein the IP packet includes an indication of a time-to-live (TTL) equal to 1.

10. The method of claim 1, wherein the router is a broadband network gateway.

11. The method of claim 1, wherein the first or second device includes any one or more of customer premises equipment or another router.

12. An apparatus comprising:
a non-transitory memory including stored instructions for controlling traffic; and
a processor operably coupled to the non-transitory memory and configured to execute the stored instructions including:
receiving, at a first Layer 3 interface of a router, traffic including an Internet Protocol (IP) packet including a multicast or broadcast destination address from a first device;
determining, based upon the first Layer 3 interface, the received IP packet belongs in a Layer 3 broadcast domain of the router;
instantiating, at the Layer 3 broadcast domain, a replica of the IP packet based upon the determination; and
transmitting, via a second Layer 3 interface of the router, the replica to a second device.

13. The apparatus of claim 12, wherein the first interface and the second interface are Layer 3 interfaces.

14. The apparatus of claim 12, wherein the router is configured to group multiple interfaces in the Layer 3 broadcast domain.

15. The apparatus of claim 14, further comprising:
transmitting, via the router, the replica to a third device via a third interface.

16. The apparatus of claim 12, further comprising:
adding an Ethernet header to the replica.

17. The apparatus of claim 16, wherein a source MAC of the Ethernet header includes an indication of a source MAC of the router.

18. The apparatus of claim 16, wherein a destination MAC of the Ethernet header includes an indication of a destination MAC of the IP packet.

19. The apparatus of claim 12, wherein the router is a broadband network gateway.

20. The apparatus of claim 12, wherein the first or second device includes any one or more of customer premises equipment or another router.
